(19) United States
(12) Patent Application Publication
(10) Pub. No.: US 2026/0100515 A1
(43) Pub. Date: Apr. 9, 2026

(54) RADIATING COAXIAL CABLE

(71) Applicant: Kabelwerk EUPEN AG, Eupen (BE)

(72) Inventors: Andy Heim, Membach (BE); Arash Sadeghfam, Aachen (DE)

(73) Assignee: KABELWERK EUPEN AG, Eupen (BE)

(21) Appl. No.: 19/351,670

(22) Filed: Oct. 7, 2025

(30) Foreign Application Priority Data
Oct. 7, 2024 (EP) 24204896.5

(51) Int. Cl. H01Q 13/20

(52) U.S. Cl. CPC H01Q 13/203

(57) ABSTRACT

A radiating cable having a longitudinal axis and including an inner conductor, an outer conductor, substantially cylindrical in shape, including a succession of arrays of aperture arrangements, the arrays being distributed along the longitudinal axis according to a sequence of pitch distances, and a dielectric material between the inner conductor and the outer conductor, wherein each array of aperture arrangements includes a number n of aperture arrangements, with n>1, wherein each pitch distance in the sequence of pitch distances is a sum of a base pitch distance and at least one adjustment distance, thereby forming a sequence of base pitch distances and at least one sequence of adjustment distances, and wherein the pitch distances vary non-periodically along the longitudinal axis.

### CROSS-REFERENCE TO RELATED APPLICATION

This application claims priority to European Patent Application No. EP24204896, filed Oct. 7, 2024, the entire disclosure of which is hereby incorporated by reference in its entirety for all purposes.

### TECHNICAL FIELD

The present disclosure relates to a radiating coaxial cable.

### BACKGROUND

Radiating cables are particularly appropriate to provide radio communication links with mobile equipment in confined areas such as tunnels, mines, underground railways and buildings.

Moreover, radiating cables can also be used in any environment to restrict the radio coverage in a narrow lateral corridor along an axis (e.g., a transport route, a railway, a defined path in a workshop, etc.) in order to avoid interferences with neighbouring transmitters operating at the same frequency.

The use of radiating cables in these environments is particularly important as a result of the development of mobile communication systems (radio links, mobile communication network, cordless telephone, wireless computer network, etc.). These mobile communications systems operate in a very wide range of frequencies. In many situations, the same radiating cable is used to transmit several frequency bands. A frequent case is the transmission of different mobile communication networks with frequency bands ranging from 75 MHz to 7000 MHz or even higher. The capacity to radiate efficiently in a broad frequency band is therefore a common requirement.

Various types of radiating cables are known. A radiating cable is typically a coaxial cable comprising an inner conductor surrounded by a dielectric material and an outer conductor of cylindrical shape. This outer conductor includes aperture arrangements which generate an electromagnetic radiation. The outer conductor is covered by an insulating outer sheath. In the following description, for the sake of conciseness, the wording “radiating cable” is sometimes replaced by “cable”.

The aperture arrangements in the outer conductor may be of various types, for example a longitudinal slot over the entire length of the cable, or numerous small holes very close to each other. There also exist cables in which the outer conductor consists of a loose braiding, or sometimes of a layer of wires helically wound around the dielectric. The common characteristic of these cables is that the whole length of the outer conductor includes aperture arrangements separated by a distance considerably shorter than the wavelength of the radiated signal. All these cables operate in a mode known as “coupled mode” in which the radiated energy propagates in the direction parallel to the cable axis. With these cables, the strength of the radiated field falls off rapidly when moving away from the cable. Moreover, the field strength fluctuates greatly along the cable. Such radiating cables are generally not appropriate for use in digital systems requiring low bit error rate.

A known solution to this problem is to use arrays of aperture arrangements which are reproduced with a constant pitch distance s. This pitch distance is of the same order of magnitude as the wavelength of the signals to be radiated. The radiation produced by the radiated mode cables propagates in a radial direction forming an angle θ₁ with the cable axis lying between 0° and 180°. Such a cable is then called a “radiated mode cable”, and is also hereinafter referred to as a “radiating cable”. Compared to coupled mode cables, the main advantage of the radiated mode cables is a stronger radiated field, which decreases less rapidly in the radial direction, and which fluctuates less along the axis of the cable. Radiated mode cables are therefore more suitable for applications requiring low bit error rate.

However, it is also known that the third advantage above (i.e. the lower field strength variations along the axis of the cable) only exists in a frequency band of one octave if the array of aperture arrangements is inappropriate (e.g. if it includes only one aperture arrangement). Indeed, when the frequency increases, there appears second order modes which propagates in various directions. Herein, a second order mode is also referred to as a “secondary propagation mode”, or simply a “secondary mode”, in contrast with a “primary propagation mode” or “main propagation mode”, or simply a “main mode”. Moreover, the higher the frequency, the more numerous are the secondary modes which all propagate in different directions and interfere either constructively or destructively. These interferences between the main and secondary modes result in rather large field strength fluctuations along the cable.

Document CN 204966704 U describes a cable intended for use outdoors rather than in tunnels. For this purpose, its radiation is emitted with the same intensity from both sides of the cable. The outer conductor of this cable has arrays of slots arranged alternately on each side of the cable.

With an appropriate design of the arrays of aperture arrangements, it is however possible to suppress or attenuate the secondary modes of propagation that create large field strength fluctuation along the cable when the frequency increases.

Document EP 1 739 789 B1 describes a very efficient solution in which all secondary modes are strongly attenuated or even suppressed in a large frequency band. Specifically, all even order secondary modes are cancelled, while the field strength corresponding to odd order secondary modes is reduced by a factor approximately equal to the order of the mode. For example, the 3^{rd} and 5^{th} modes are reduced by a factor of about 3 and 5 respectively.

However, the various known radiated mode cable designs have a disadvantage of having a high Voltage Standing Wave Ratio (VSWR) at certain frequencies (called “resonance frequencies”) or even in certain bands (called “stop bands”) where these cables are therefore unsuitable for use.

VSWR is known by a person skilled in the art as a measure of how efficiently radio-frequency power is radiated by an antenna rather than reflected within an antenna. If a reflection coefficient of an antenna is designated by Γ, then the VSWR of the antenna may be expressed as

$$V S W R = \frac{1 + \vert Γ \vert}{1 - \vert Γ \vert} .$$

In an ideal system, all radio-frequency power is radiated and no reflection occurs, i.e. Γ=0, and therefore VSWR is equal to 1. In a real system however, some radio-frequency power may be reflected within the antenna rather than being radiated by the antenna, leading to a VSWR greater than 1. In summary, the closer the VSWR is to a minimal value of 1, the closer the system is to an ideal system where no reflection occurs.

Document EP 4 037 100 A1 describes a radiating cable whose outer conductor includes arrays including two rows of aperture arrangements periodically distributed along two substantially diametrically opposed generatrixes. The arrays of two rows of aperture arrangements are configured in such a way that the secondary propagation modes are attenuated or suppressed, and that no resonance frequency or stop band appear within a chosen frequency band.

Document US 2010/0001817 A1 describes a cable wherein a pitch distance between arrays of aperture arrangements is periodically changed in the longitudinal direction according to a sinusoidal function, a quadratic function, or other functions in order to attenuate the VSWR related to resonance. The document shows however that only the 3 first VSWR peaks are reduced (but not completely cancelled) and that the 4th peak is still present.

When a radiating cable is connected to a transmitter/receiver (hereinafter referred to as Tx/Rx for short) at one end, the signal provided by the transmitter propagates through the cable. Each aperture arrangement creates an impedance mismatch that produces a reflection that returns to the transmitter. These reflections cause interference within the cable, thereby leading to an increased VSWR. When a wavelength of a signal propagating through the cable is equal to the pitch distance between arrays of aperture arrangements, the reflections produced by the aperture arrangements arrive in phase at the end of the cable connected to the Tx/Rx and a resonant mode is established for the wavelength, which may be called a resonant wavelength, and the corresponding frequency, which may be called a resonant frequency. This accumulation of in-phase reflections produces a strong signal that may saturate the receiver. Resonant modes also exist for harmonics of the resonant frequency, i.e. frequencies that are an integer multiple of the resonant frequency, an integer multiple of a quantity being the product of the quantity and an integer. A harmonic of a resonant frequency corresponds to a wavelength that is an integer submultiple of the resonant wavelength corresponding to the resonant frequency, an integer submultiple of a quantity being the quotient of the quantity and an integer. A resonant mode causes a peak of VSWR for a resonant frequency corresponding to the resonant mode, thereby leading to an increased bit error rate in a frequency band comprising the resonant frequency, and therefore degrading the transmission and reception performances of the radiating cable in the frequency band.

### SUMMARY

An object of the present disclosure is to provide a radiating cable with a low VSWR wherein the undesirable secondary modes are cancelled, or at least attenuated.

There is a need for a so-called broadband radiating cable, i.e. a radiating cable allowing the transmission and reception of a signal in a large band of frequencies wherein the resonant modes are strongly attenuated, or even almost suppressed. In addition, to guarantee good radiation performances of the radiating cable, and in particular to avoid large field strength fluctuations along the cable, it is desirable that the secondary propagation modes are cancelled, or at least attenuated.

To this end, embodiments of the present disclosure provides a radiating cable having a longitudinal axis and comprising:
an inner conductor,
an outer conductor, substantially cylindrical in shape, comprising a succession of arrays of aperture arrangements, the arrays being distributed along the longitudinal axis according to a sequence of pitch distances, and
a dielectric material between the inner conductor and the outer conductor,
   wherein each array of aperture arrangements comprises a number n of aperture arrangements, with n>1, and wherein each pitch distance in the sequence of pitch distances is a sum of a base pitch distance and at least one adjustment distance, thereby forming a sequence of base pitch distances and at least one sequence of adjustment distances, characterized in that the pitch distances vary non-periodically along the longitudinal axis.

Having a non-periodic variation of a pitch distance separating consecutive arrays of aperture arrangements along the longitudinal axis of a cable may attenuate the amplitude of the resonant modes that may arise within the cable at certain frequencies, thereby leading to a lower amplitude of VSWR peaks and therefore an overall lower VSWR.

Having a number n of aperture arrangements larger than one in each array of aperture arrangements in a radiating cable helps attenuate the amplitude of undesirable secondary modes.

The present disclosure includes several possible embodiments comprising optional features, where some of them can be combined.

In an embodiment of the present disclosure, adjustment distances within a sequence of adjustment distances vary according to a non-periodic mathematical function along the longitudinal axis of the cable. The non-periodic mathematical function may be for instance a linear function, a quadratic function, or an exponential function. In some embodiments, using adjustment distances varying along the longitudinal axis of the cable according to a non-periodic mathematical function such as a linear function, a quadratic function, or an exponential function has the ability to attenuate the amplitude of the resonant modes that may arise within the cable at certain frequencies, thereby leading to a lower amplitude of VSWR peaks and therefore an overall lower VSWR.

In an embodiment of the present disclosure, adjustment distances within a sequence of adjustment distances vary according to a non-periodic pseudorandom function along the longitudinal axis of the cable. The non-periodic pseudorandom function may have the appearance of a random function, but it can be generated by a definite computational process such as an optimization process aiming at minimizing the amplitude of the VSWR in a given frequency range. In some embodiments, using adjustment distances varying along the longitudinal axis of the cable according to a non-periodic pseudorandom function generated by such an optimization process has the ability to attenuate the amplitude of the resonant modes that may arise within the cable at certain frequencies, thereby leading to a lower amplitude of VSWR peaks and therefore an overall lower VSWR.

Features of the two preceding embodiments may be combined, for instance with each pitch distance in a sequence of pitch distances separating consecutive arrays of aperture arrangements along the longitudinal axis of the cable being the sum of a base distance, a first adjustment distance, and a second adjustment distance, the first adjustment distances varying along the longitudinal axis of the cable according to a non-periodic mathematical function such as a linear function, the second adjustment distances varying along the longitudinal axis of the cable according to a non-periodic pseudorandom function that may be for example generated by an optimization process.

In an embodiment of the present disclosure, the sum of all adjustment distances for a pitch distance is at most 50% of the base pitch distance corresponding to the pitch distance, at most 20% of the base pitch distance, at most 7% of the base pitch distance, or at most 5% of the base pitch distance. In the embodiment, aperture arrangements of an array of aperture arrangements may only span half of the base pitch distance separating the array from the next array along the longitudinal axis of the cable. In such a case, having a sum of all adjustment distances separating the arrays that is larger than half of the base pitch distance may lead to an overlap of consecutive arrays of aperture arrangements, which is not desirable since it would deteriorate the radiation performances of the cable. Therefore, the sum of all adjustment distances for a pitch distance may be at most 50% of the base pitch distance corresponding to the pitch distance. In addition, improved radiation performances of a cable may be achieved when the sum of all adjustment distances for a pitch distance was at most 20% of the base pitch distance corresponding to the pitch distance. Improved radiation performances of a cable may be achieved when the sum of all adjustment distances for a pitch distance was at most 7% of the base pitch distance corresponding to the pitch distance. Improved radiation performances of a cable may be achieved when the sum of all adjustment distances for a pitch distance was at most 5% of the base pitch distance corresponding to the pitch distance.

In an embodiment of the present disclosure, all base pitch distances in the sequence of base pitch distances are equal to a constant value b that fulfils the conditions

$${f}_{start} > \frac{300}{( \sqrt{{ε}_{r}} + 1 ) \times b} and {f}_{end} < \frac{300}{( \sqrt{{ε}_{r}} - 1 ) \times b}$$

wherein fₛₜₐᵣₜ and f_{end} are respectively the lower and higher limits of the frequency range within which the main radiated mode of the radiating cable exists, and Er is the relative permittivity of the dielectric material. Frequencies fₛₜₐᵣₜ and f_{end} are respectively the lower and higher limits of the frequency range that the radiating cable is designed for, and therefore within which the radiating cable is intended to operate. In the formulas of the conditions, frequencies are expressed in megahertz (MHz), and distances such as the base pitch distance b are expressed in meters (m). The relative permittivity εᵣ is a dimensionless number.

In an embodiment of the present disclosure, the number n of aperture arrangements in each array of aperture arrangements is at least ten. With at least ten aperture arrangements in each array of aperture arrangements, the undesirable secondary modes are strongly attenuated.

In some embodiments, the number n of aperture arrangements in each array of aperture arrangements is at least fifteen. With at least fifteen aperture arrangements in each array of aperture arrangements, the undesirable secondary modes are even more strongly attenuated.

Each aperture arrangement comprises at least one aperture. In an embodiment of the present disclosure, each aperture arrangement consists in a single aperture.

In some embodiments, the apertures are elongated, with an aperture axis making an angle α comprised between 10° and 90° with the longitudinal axis of the radiating cable.

In an embodiment of the present disclosure, each aperture arrangement comprises at least two apertures. The at least two apertures of each aperture arrangement can be transversally and/or longitudinally shifted with respect to each other. Cables with aperture arrangements having more than two apertures have to be considered part of the scope of the present disclosure.

In an embodiment of the disclosure, consecutive arrays of aperture arrangements are grouped into groups of arrays of aperture arrangements, two consecutive groups being separated by an additional longitudinal distance, the additional longitudinal distances separating consecutive groups of arrays of aperture arrangements varying linearly along the longitudinal axis of the cable. Having consecutive groups of arrays of aperture arrangements separated by additional longitudinal distances, the additional longitudinal distances varying along the longitudinal axis of the cable, may enable an easier manufacturing of the cable by allowing usage of a same sequence of pitch distances in each group while keeping an overall non-periodic sequence of pitch distances along the cable, thereby preserving a low amplitude of VSWR peaks and therefore an overall low VSWR.

In some embodiments, a group of arrays of aperture arrangements comprises at least 3 arrays of aperture arrangements, can have at least 10 arrays of aperture arrangements, or can have at least 50 arrays of aperture arrangements. Indeed, a group of arrays of aperture arrangements must comprise at least 3 arrays of aperture arrangements to allow a non-periodic variation of the pitch distances along the longitudinal axis of the cable. In addition, having at least 10 arrays of aperture arrangements in each group of arrays of aperture arrangements allowed a better attenuation of the amplitude of the resonant modes that may arise within the cable at certain frequencies. Further, having at least 50 arrays of aperture arrangements in each group of arrays of aperture arrangements allowed an even better attenuation of the amplitude of the resonant modes that may arise within the cable at certain frequencies.

In an embodiment of the present disclosure, the succession of arrays of aperture arrangements comprises at least 40 arrays of aperture arrangements, at least 100 arrays of aperture arrangements, or at least 200 arrays of aperture arrangements.

The present disclosure also provides for a radiating cable installation along a surface, that can be for example a wall, a ceiling, or a floor, and comprising a radiating cable according to the present disclosure and the surface.

The present disclosure also provides for a process of making a radiating cable, and comprising the following steps:
a. providing an inner conductor made of an electrically conductive material,
b. providing a dielectric material,
c. assembling the dielectric material around the inner conductor,
d. providing a sheet of electrically conductive material,
e. punching aperture arrangements in the sheet of electrically conductive material in such a way that the punched aperture arrangements form a succession of arrays of aperture arrangements, the arrays being distributed along a longitudinal axis of the radiating cable according to a sequence of pitch distances, wherein each array of aperture arrangements comprises a number n of aperture arrangements, with n>1, wherein each pitch distance in the sequence of pitch distances is a sum of a base pitch distance and at least one adjustment distance, thereby forming a sequence of base pitch distances and at least one sequence of adjustment distances, and wherein the pitch distances vary non-periodically along the longitudinal axis,
f. assembling the punched sheet of electrically conductive material around the dielectric material to form an outer conductor substantially cylindrical in shape.

The aforementioned steps can be executed in the order listed above, i.e. the alphabetical order. However, executing some steps in another order is possible and remains within the scope of the present disclosure. An electrically conductive material may be for example copper, or a copper alloy. A dielectric material may be for example polyethylene (PE). Assembling the punched sheet of electrically conductive material around the dielectric material may be performed for example by wrapping, gluing, or other means.

All the embodiments and advantages of a radiating cable according to the present disclosure apply mutatis mutandis to the present process of making a radiating cable.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 illustrates an array of aperture arrangements repeated at a constant pitch s in accordance with an aspect of the present disclosure;

FIG. 2 represents the variation of the direction of propagation of the main mode versus frequency if √εᵣ=1.11;

FIG. 3 represents a three-dimensional view a possible embodiment of a radiating cable in accordance with an aspect of the present disclosure;

FIG. 4 represents a top view of a possible embodiment of a radiating cable in accordance with an aspect of the present disclosure;

FIGS. 5a-5c represent adjustment distances varying according to a non-periodic mathematical function, respectively a linear function, a quadratic function, and an exponential function;

FIG. 6 represents adjustment distances varying according to a non-periodic pseudorandom function;

FIG. 7 represents adjustment distances varying according to a combination of a linear mathematical function and a non-periodic pseudorandom function;

FIGS. 8a and 8b represent a top view of two possible embodiments in accordance with an aspect of the present disclosure, wherein the aperture arrangements are transverse slots and slanted slots;

FIGS. 9a and 9b represent a top view of two possible embodiments in accordance with an aspect of the present disclosure, wherein the aperture arrangements have the advantage of being less directional, thus avoiding low radiation in certain directions of the main propagation mode; and

FIGS. 10a-10d represent a top view of several possible embodiments in accordance with an aspect of the present disclosure, wherein the aperture arrangements comprise a plurality of apertures.

The figures are not drawn to scale. Generally, identical or analogous elements are denoted by the same reference numerals or letters in the figures.

### DETAILED DESCRIPTION

The detailed description set forth below in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed.

Furthermore, the terms “first”, “second”, “third” and the like, in the description and in the claims, are used for distinguishing between similar elements and not necessarily for describing a sequential or chronological order. The terms are interchangeable under appropriate circumstances and the embodiments of the present disclosure can operate in other sequences than described or illustrated herein.

Herein, the longitudinal axis of a cable is also simply referred to as “the cable axis”. The expressions “longitudinal direction”, “transverse direction” and “slanted direction” as used herein refer respectively to the directions parallel, perpendicular and slanted to the cable axis. The “axial direction” is parallel to the cable axis. The “radial direction” corresponds to a direction forming with the cable axis an angle lying between 0° and 180°.

The expression “aperture arrangement” as used herein refers either to a single aperture or to a plurality of apertures in the outer conductor of a radiating cable. The apertures of a plurality may be identical or different and collectively, for the purpose of the present disclosure, may behave as one single aperture. Elliptical shaped aperture the main axis of which is either transverse or slanted with respect to the longitudinal direction is used for the description of some embodiments. Slot with rounded ends is another embodiment of the present disclosure. Many other embodiments allow to achieve the sought effect however. For instance, the single aperture arrangement may have a circular or oval shape. Aperture arrangements of more complex shape are also described later, as well as aperture arrangements comprising several apertures. The sizes of the aperture arrangements can be chosen to control the strength of the radiated field.

The expression “array of aperture arrangements” as used herein refers to any regular pattern of aperture arrangements in the outer conductor of a radiating cable, an array of aperture arrangements comprising a number of identical or similar aperture arrangements repeated regularly along the longitudinal axis of the cable, a pair of consecutive arrays of aperture arrangements along the longitudinal axis of the cable being separated by a pitch distance.

The expression “group of arrays of aperture arrangements” as used herein refers to a group comprising a number of consecutive arrays of aperture arrangements along the longitudinal axis of the cable.

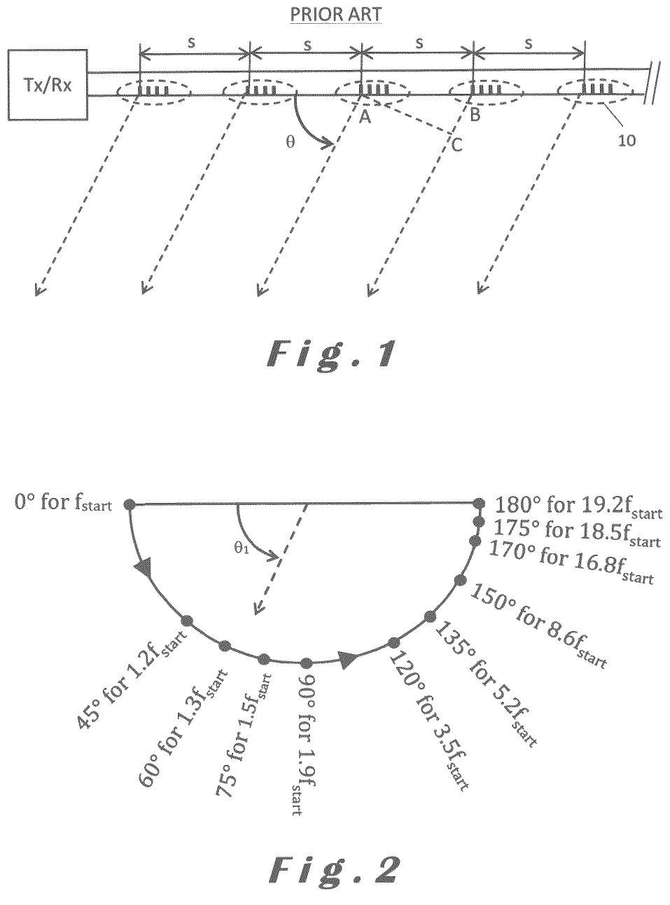

FIG. 1 illustrates the principle of a radiated mode cable according to the state of the art. The outer conductor of such a cable includes arrays 10 of aperture arrangements which are repeated at a constant pitch s, this pitch being of the same order of magnitude as the wavelength of the signals to be radiated. The radiation produced by a radiated mode cable propagates in a radial direction forming an angle θ with the cable axis, θ lying between 0° and 180°.

FIG. 1 also represents, in any plane containing the cable axis, the paths of the wave radiated, in a direction θ, by the first aperture arrangement of two adjacent arrays. In this direction θ, the path difference corresponds to the length ABC (with AC perpendicular to BC). The time delay Δτ corresponding to this path difference is

$$Δ τ = \frac{s}{v} + \frac{s \cdot cos θ}{c} = \frac{s}{c} ( \sqrt{{ε}_{r}} + cos θ ) \qquad ( 1 )$$

where ν is the wave velocity inside the cable, s is the pitch of the arrays of aperture arrangements, and εᵣ the relative permittivity of the dielectric material between the inner and outer conductors. With the dielectric materials usually used in the manufacture of radiating cables, √εᵣ is generally lying between 1.1 and 1.15. Some examples of calculations given hereafter have been carried out with √εᵣ=1.11, which is quite representative for the dielectric materials currently in use. It should be stressed, however, that the conclusions drawn from these calculations will generally also be valid if √εᵣ differs from this particular value.

The corresponding phase shift φ (in radians) is therefore

$$ϕ = 2 π \frac{Δτ \cdot c}{λ} = 2 π \frac{s}{λ} ( \sqrt{{ε}_{r}} + cos θ ) \qquad ( 2 )$$

where λ the signal wavelength in the air. The waves radiated by two adjacent arrays of aperture arrangements add up in phase if φ is a multiple of 2π, i.e.:

$$ϕ = 2 k π with k = 1 , 2 , 3 , … \qquad ( 3 )$$

Substituting equation (3) into equation (2) allows to determine the directions θₖ of maximum radiation (also termed “propagation modes”) given by

$$cos {θ}_{k} = \frac{k λ}{s} - \sqrt{{ε}_{r}} with k = 1 , 2 , 3 , … \qquad ( 4 )$$

In the case of the main propagation mode, i.e. for which k=1, equation (4) reduces to

$$cos {θ}_{1} = \frac{λ}{s} - \sqrt{{ε}_{r}} \qquad ( 5 )$$

Therefore, if the direction of reference for measuring θ₁ is the direction of the cable end connected to a Tx/Rx, θ₁ is given by:

$${θ}_{1} = arcos [ \frac{λ}{s} - \sqrt{{ε}_{r}} ] \qquad ( 6 )$$

Equation (5) has a solution if it gives a cos in the interval [−1; +1]. This provides a range of wavelength at a given value of s, which corresponds to a main mode propagating in a direction ranging between θ₁=0° and θ₁=180°. The direction θ₁ of propagation of the wave is equal to 0° and 180° respectively for wavelengths (in the air) λₛₜₐᵣₜ and λ_{end} given by

$${λ}_{start} = ( \sqrt{{ε}_{r}} + 1 ) \times s and {λ}_{end} = ( \sqrt{{ε}_{r}} - 1 ) \times s \qquad ( 7 )$$

The frequencies fₛₜₐᵣₜ and f_{end} (in MHz) corresponding to λₛₜₐᵣₜ and λ_{end} (in meters) are given by

$${f}_{start} = \frac{300}{( \sqrt{{ε}_{r}} + 1 ) \times s} and {f}_{end} = \frac{300}{( \sqrt{{ε}_{r}} - 1 ) \times s} = \frac{\sqrt{{ε}_{r}} + 1}{\sqrt{{ε}_{r}} - 1} \times {f}_{start} \qquad ( 8 )$$

The diagram in FIG. 2 shows the evolution of θ₁ as the frequency increases from fₛₜₐᵣₜ to f_{end} if √εᵣ=1.11. It shows that, with such dielectric relative permittivity, f_{end} is about 19.2×fₛₜₐᵣₜ.

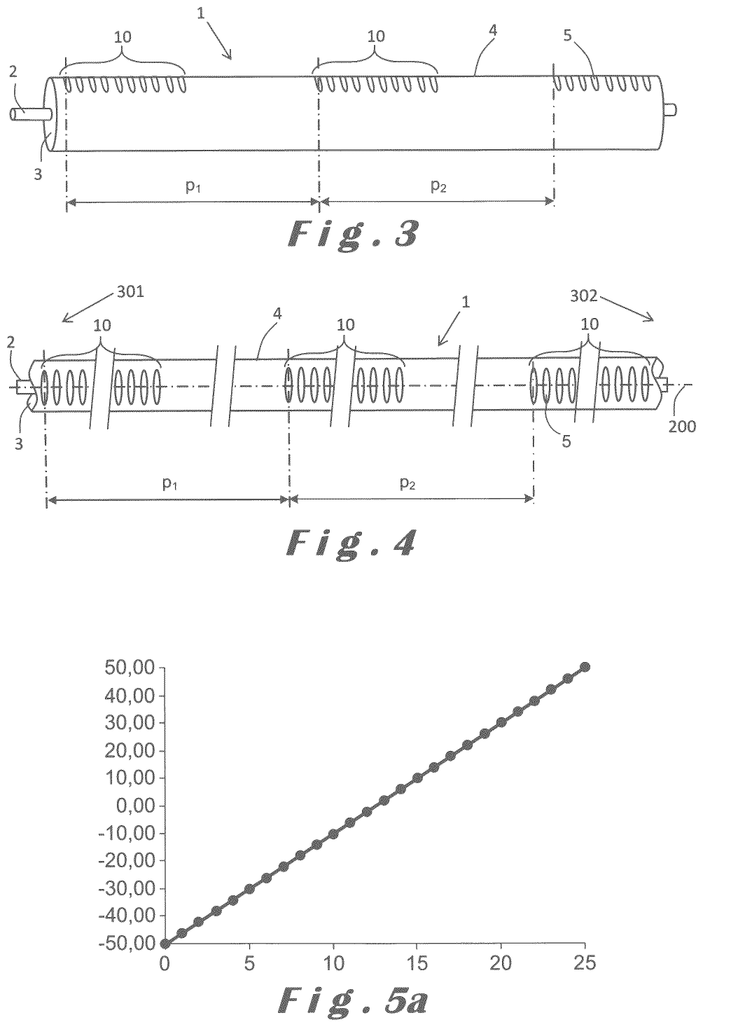

FIGS. 3 and 4 illustrate a radiating cable 1 according to an embodiment of the present disclosure. The radiating cable 1 is a coaxial cable comprising, in this order, moving radially away from the longitudinal axis 200: an inner conductor 2, a dielectric material 3, an outer conductor 4 substantially cylindrical in shape, and an insulating outer sheath (non-illustrated). The radiating cable 1 has a first end 301 connected to a Tx/Rx, and a second end 302 opposite to the first end 301.

The outer conductor 4 comprises a plurality of arrays 10 of aperture arrangements 5 distributed along the longitudinal axis 200 of the cable according to a sequence of pitch distances p₁, p₂, each pitch distance p in the sequence of pitch distances p₁, p₂ being a sum of a base pitch distance and at least one adjustment distance. Each array 10 of aperture arrangements comprises a number n of aperture arrangements 5, with n being larger than 1.

A pitch distance p separating consecutive arrays 10 of aperture arrangements 5 refers to the distance measured, along the longitudinal axis 200, between the centres of the first aperture arrangement of two consecutive arrays 10 of aperture arrangements 5.

FIG. 4 is a top view of the outer conductor 4 of the radiating cable 1 according to an embodiment of the present disclosure. In this embodiment, the aperture arrangements 5 are elliptical in shape and elongated in the transverse direction.

Tests were performed in simulation according to the prior art and several embodiments of the present disclosure. Table 1 summarizes results of the tests performed. These results are given by way of example and cannot be construed as limiting the scope of the present disclosure in any manner. For each test, the maximum value of the VSWR is reported. As stated hereinabove, the closer the VSWR is to a minimal value of 1, the less reflections occur within a radiating cable. Simulation conditions and details of each test are provided hereinafter.

TABLE 1
Summary of simulation results

| Test | | Maximum VSWR |
|---|---|---|
| number | Adjustment distance variation | (0.5-1 GHz) |
| Test 1 | No variation (prior art) | 3.10 |
| Test 2 | Periodic sinusoidal function (prior art) | 1.62 |
| Test 3 | Non-periodic mathematical function | 1.56 |
| | (linear function) | |
| Test 4 | Non-periodic pseudorandom function | 1.30 |
| Test 5 | Combination of non-periodic mathematical | 1.50 |
| | function (linear function) and non- | |
| | periodic pseudorandom function | |

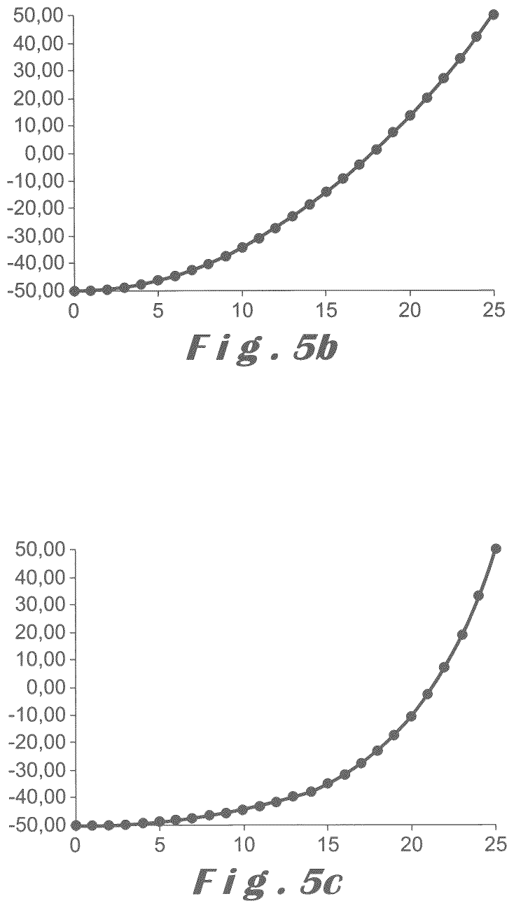

In the tests performed, each array of aperture arrangements comprises 72 aperture arrangements, the centres of consecutive aperture arrangements in an array of aperture arrangements being separated by 15 mm. The tests were performed for a radiating cable comprising 26 arrays of aperture arrangements separated by a sequence of pitch distances. The pitch distance separating two consecutive arrays of aperture arrangements along the longitudinal axis of the cable is the sum of a base pitch distance and one or several adjustment distances. The base pitch distance is set to 216 cm. The sum of all adjustment distances for a pitch distance is comprised between −50 mm and +50 mm, as illustrated in FIGS. 5, 6, and 7.

In Test 1, no variation of the pitch distance was performed; the adjustment distances were all set to zero. Test 1 serves as a reference to compare results according to the present disclosure with results according to the prior art with no variation of the pitch distance separating consecutive arrays of aperture arrangements.

In Test 2, a periodic variation of the pitch distance was performed; the adjustment distances varied according to a sinusoidal function with an amplitude of 50 mm. Test 2 serves as a reference to compare results according to the present disclosure with results according to the prior art with a periodic variation of the pitch distance separating consecutive arrays of aperture arrangements.

In Test 3, the adjustment distance varied according to a non-periodic mathematical function, namely a linear function, as illustrated in FIG. 5a. Hereinafter, a non-periodic mathematical function is also simply referred to as a “mathematical function” for the sake of conciseness. Other examples of mathematical functions are possible according to the present disclosure, such as a quadratic function, as illustrated in FIG. 5b, and an exponential function, as illustrated in FIG. 5d.

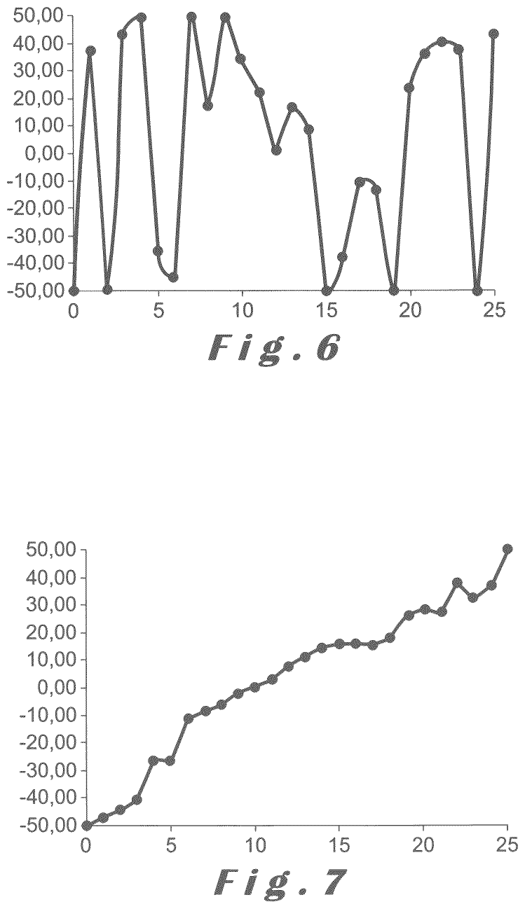

In Test 4, the adjustment distance varied according to a non-periodic pseudorandom function, as illustrated in FIG. 6. Hereinafter, a non-periodic pseudorandom function is also simply referred to as a “pseudorandom function” for the sake of conciseness. As stated hereinabove, a pseudorandom function has the appearance of a random function, but is generated by a definite computational process, such as for instance an optimization process performed by an optimizer. In the context of Test 4, an optimizer was given an initial set of adjustment distances values comprised between −50 mm and +50 mm and modified the values of the set through the application of a gradient descent algorithm in multiple iterations, typically 100 iterations, with the aim of minimizing the amplitude of the VSWR in a frequency range comprised between 0.5 GHz and 1 GHz, and with the constraint to keep the values of the set between −50 mm and +50 mm. FIG. 6 illustrates the result of the optimization process performed by the optimizer in the context of Test 4, which may be considered as a non-periodic pseudorandom function according to the present disclosure.

In Test 5, the adjustment distance varied according to a combination of a non-periodic mathematical function, namely a linear function, and a non-periodic pseudorandom function, as illustrated in FIG. 7. Test 5 provides an example of the case where a pitch distance separating consecutive arrays of aperture arrangements is a sum of a base pitch distance and more than one adjustment distances, as is permitted in the context of the present disclosure. Indeed, the adjustment distance as illustrated in FIG. 7 in the context of Test 5 may be viewed as a sum of a linear function and a pseudorandom function. In addition, Test 5 has been experimentally validated.

Simulation results summarized in Table 1 show that results according to the present disclosure allows achieving of a lower maximal VSWR value and thus a lower overall VSWR in a frequency range than results according to the prior art.

In an embodiment of the present disclosure, a number of consecutive arrays of aperture arrangements are grouped into groups of arrays of aperture arrangements, two consecutive groups being separated by an additional longitudinal distance. In this embodiment, the additional longitudinal distance separating two groups may be viewed as an additional term in the sum of adjustment distances for the pitch distance separating the last array of a group of arrays and the first array of a consecutive group of arrays along the longitudinal axis of the cable. In some embodiments, the additional longitudinal distances separating consecutive groups of arrays of aperture arrangements vary linearly along the longitudinal axis of the cable.

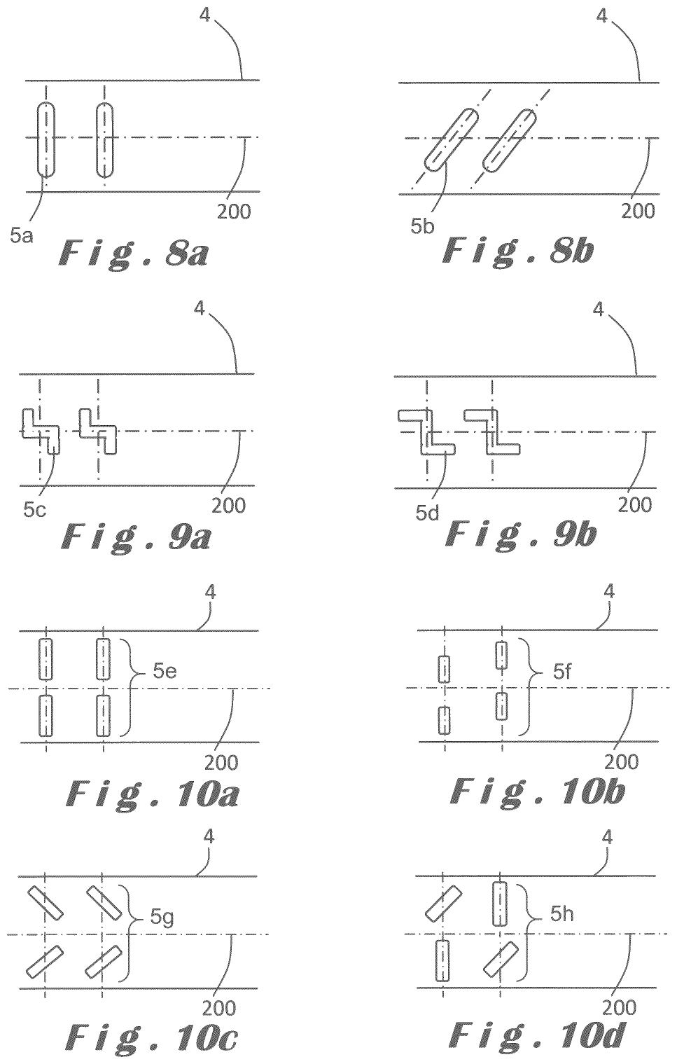

FIGS. 8, 9, and 10 show some possible embodiments of aperture arrangements 5a, 5b, 5c, 5d, 5e, 5f, 5g, and 5h according to the present disclosure in a top view of the outer conductor 4 of the radiating cable 1.

In FIGS. 8a and 8b, aperture arrangements 5a and 5b are slots with rounded ends. In FIG. 8a, slots are oriented in a transverse direction, i.e. perpendicular to the longitudinal axis 200. In FIG. 8b, slots are oriented in a slanted direction with respect to the longitudinal axis 200.

FIGS. 9a and 9b respectively show more complex aperture arrangements 5c and 5d comprising slot sections oriented in the longitudinal and transverse directions. Such aperture arrangements have the advantage of being less directional, thus avoiding low radiation in certain directions of the main propagation mode. Other aperture arrangements similar to those illustrated in FIG. 9 are possible and have to be considered part of the scope of the present disclosure.

Instead of a single aperture, an aperture arrangement 5 according to the present disclosure may include a plurality of apertures as illustrated by several examples 5e, 5f, 5g, 5h respectively represented at FIGS. 10a-10d. In the context of the present disclosure, an aperture arrangement comprising a plurality of apertures may be regarded as behaving as a single aperture.

According to the present disclosure, the aperture arrangements 5 in an array 10 of aperture arrangements have substantially the same reflection coefficient and substantially identical radiation patterns, so that they produce substantially the same field strength for a given current flowing in the outer conductor of the cable. This is the case if they are identical, but may also be the case if they differ in shape and/or size. It may also not be required that the centres of all aperture arrangements 5 are perfectly aligned with the longitudinal axis 200.

FIG. 10a illustrates an embodiment in which an aperture arrangement 5e comprises two identical slots.

FIG. 10b illustrates an embodiment in which an aperture arrangement 5f comprises two identical slots. The centre of the aperture arrangement 5f is not perfectly aligned with the longitudinal axis 200.

FIG. 10c illustrates an embodiment in which an aperture arrangement 5g comprises two slots slanted in opposite directions.

FIG. 10d illustrates an embodiment in which an aperture arrangement 5h comprises one transverse and one slanted slot.

In summary, the present disclosure relates to a radiating cable having a longitudinal axis and comprising an inner conductor, an outer conductor, substantially cylindrical in shape, comprising a succession of arrays of aperture arrangements, the arrays being distributed along the longitudinal axis according to a sequence of pitch distances, and a dielectric material between the inner conductor and the outer conductor, wherein each array of aperture arrangements comprises a number n of aperture arrangements, with n>1, wherein each pitch distance in the sequence of pitch distances is a sum of a base pitch distance and at least one adjustment distance, thereby forming a sequence of base pitch distances and at least one sequence of adjustment distances, and wherein the pitch distances vary non-periodically along the longitudinal axis.

In the foregoing description, specific details are set forth to provide a thorough understanding of exemplary embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 10% of the stated value. For the purposes of the present disclosure, the phrase “at least one of A and B” is equivalent to “A and/or B” or vice versa, namely “A” alone, “B” alone, or “A and B.” Similarly, the phrase “at least one of A, B, and C,” for example, means (A), (B), (C), (A and B), (A and C), (B and C), or (A, B, and C), including all further possible permutations when greater than three elements are listed.

It should be noted that for purposes of this disclosure, terminology such as “upper,” “lower,” “vertical,” “horizontal,” “fore,” “aft,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

Throughout this specification, terms of art may be used. These terms are to take on their ordinary meaning in the art from which they come, unless specifically defined herein or the context of their use would clearly suggest otherwise.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

The embodiments of the invention in which an exclusive property or privilege is claimed are defined as follows:

1. A radiating cable having a longitudinal axis and comprising:
an inner conductor;
an outer conductor, substantially cylindrical in shape, having a succession of arrays of aperture arrangements, the arrays being distributed along the longitudinal axis according to a sequence of pitch distances; and
a dielectric material between the inner conductor and the outer conductor,
wherein each array of aperture arrangements has a number n of aperture arrangements, with n>1, and wherein each pitch distance in the sequence of pitch distances is a sum of a base pitch distance and at least one adjustment distance, thereby forming a sequence of base pitch distances and at least one sequence of adjustment distances,
wherein the pitch distances vary non-periodically along the longitudinal axis.

2. The radiating cable according to claim 1, wherein adjustment distances within a sequence of adjustment distances vary according to a non-periodic mathematical function along the longitudinal axis.

3. The radiating cable according to claim 1, wherein adjustment distances within a sequence of adjustment distances vary according to a non-periodic pseudorandom function along the longitudinal axis.

4. The radiating cable according to claim 1, wherein the sum of all adjustment distances for a pitch distance is at most 50% of the base pitch distance corresponding to the pitch distance.

5. The radiating cable according to claim 1, wherein the sum of all adjustment distances for a pitch distance is at most 20% of the base pitch distance.

6. The radiating cable according to claim 1, wherein the sum of all adjustment distances for a pitch distance is at most 7% of the base pitch distance.

7. The radiating cable according to claim 1, wherein the sum of all adjustment distances for a pitch distance is at most 5% of the base pitch distance.

8. The radiating cable according to claim 1, wherein all base pitch distances in the sequence of base pitch distances are equal to a constant value b that fulfils the conditions
$${f}_{start} > \frac{300}{( \sqrt{{ε}_{r}} + 1 ) \times b} and {f}_{end} < \frac{300}{( \sqrt{{ε}_{r}} - 1 ) \times b}$$
wherein fₛₜₐᵣₜ and f_{end} are respectively the lower and higher limits of the frequency range within which the main radiated mode of the radiating cable exists, and Er is the relative permittivity of the dielectric material.

9. The radiating cable according to claim 1, wherein the number n of aperture arrangements in each array of aperture arrangements is at least 10.

10. The radiating cable according to claim 9, wherein the number n of aperture arrangements in each array of aperture arrangements is at least 15.

11. The radiating cable according to claim 1, wherein each aperture arrangement consists in a single aperture.

12. The radiating cable according to claim 11, wherein the apertures are elongated, with an aperture axis making an angle α comprised between 10° and 90° with the longitudinal axis of the radiating cable.

13. The radiating cable according to claim 1, wherein each aperture arrangement comprises at least two apertures.

14. The radiating cable according to claim 1, wherein consecutive arrays of aperture arrangements are grouped into groups of arrays of aperture arrangements, two consecutive groups being separated by an additional longitudinal distance, the additional longitudinal distances separating consecutive groups of arrays of aperture arrangements varying linearly along the longitudinal axis of the cable.

15. The radiating cable according to claim 14, wherein a group of arrays of aperture arrangements comprises at least 3 arrays of aperture arrangements.

16. The radiating cable according to claim 14, wherein a group of arrays of aperture arrangements comprises at least 10 arrays of aperture arrangements.

17. The radiating cable according to claim 14, wherein a group of arrays of aperture arrangements comprises at least 50 arrays of aperture arrangements.

18. The radiating cable according to claim 1, wherein the succession of arrays of aperture arrangements comprises at least 40 arrays of aperture arrangements, at least 100 arrays of aperture arrangements, or at least 200 arrays of aperture arrangements.

19. A radiating cable installation comprising a radiating cable according to claim 1 and a surface.

20. A process of making a radiating cable according to claim 1, and comprising:
providing an inner conductor made of an electrically conductive material;
providing a dielectric material;
assembling the dielectric material around the inner conductor;
providing a sheet of electrically conductive material;
punching aperture arrangements in the sheet of electrically conductive material in such a way that the punched aperture arrangements form a succession of arrays of aperture arrangements, the arrays being distributed along a longitudinal axis of the radiating cable according to a sequence of pitch distances, wherein each array of aperture arrangements comprises a number n of aperture arrangements, with n>1, wherein each pitch distance in the sequence of pitch distances is a sum of a base pitch distance and at least one adjustment distance, thereby forming a sequence of base pitch distances and at least one sequence of adjustment distances, and wherein the pitch distances vary non-periodically along the longitudinal axis; and
assembling the punched sheet of electrically conductive material around the dielectric material to form an outer conductor substantially cylindrical in shape.
